(19) United States
(12) Patent Application Publication
(10) Pub. No.: US 2018/0249473 A1
(43) Pub. Date: Aug. 30, 2018

(54) COMMUNICATION SYSTEM AND BASE STATION APPARATUS

(71) Applicant: SHARP KABUSHIKI KAISHA, Sakai City, Osaka (JP)

(72) Inventors: HIROMICHI TOMEBA, Sakai City (JP); TOMOKI YOSHIMURA, Sakai City (JP); YASUHIRO HAMAGUCHI, Sakai City (JP)

(21) Appl. No.: 15/755,093

(22) PCT Filed: Aug. 26, 2016
(86) PCT No.: PCT/JP2016/074918

§ 371 Date: Feb. 26, 2018

(30) Foreign Application Priority Data
Aug. 31, 2015 (JP) 2015-170061

(51) Int. Cl. H04W 72/08; H04W 72/04; H04W 64/00

(52) U.S. Cl. CPC H04W 72/085; H04W 72/0413; H04W 84/045; H04W 64/00; H04W 72/042; H04W 72/046

(57) ABSTRACT

A communication service that needs a plurality of different required conditions is efficiently provided. According to an aspect of the present invention, there is provided a communication system that includes a base station apparatus and a terminal apparatus and provides a communication service based on a plurality of communication modes that satisfy different communication qualities, in which the plurality of communication modes includes a first communication mode and a second communication mode, in which a communication route included in the first communication mode and a communication route included in the second communication mode are different from each other, and in which a trigger for the base station apparatus to start communication based on the second communication mode is included in information transmitted by the terminal apparatus in accordance with the first communication mode.

### TECHNICAL FIELD

The present invention relates to a communication system and a base station apparatus.

### BACKGROUND ART

The 5th Generation mobile radio communication system is required to satisfy required conditions which assume all use cases (a service scene, a use scene) including a cellular service that is expected for the fourth generation mobile radio communication system represented by Long Term Evolution (LTE) (see NPL 1).

A large capacity communication and a low latency communication are given as the required conditions of the 5G system. Transfer that uses wireless communication of an image that has ultra-high image quality, such as 4K or 8K and of moving image data is given as the use case that is required by the large capacity communication. Furthermore, remote operation of a robot is given as the use case that is required by the low latency communication. In order to realize the large capacity communication, a communication system has to secure many radio resources, and additionally, has to improve a reception quality greatly. On the other hand, in order to realize the low latency communication, the communication system needs to proceed with shortening of a signal frame length, simplification of transmission and reception of control information, or the like. At this time, technical requirements that the communication system needs in order to realize the large capacity communication do not include all technical requirements that are needed in order to realize the low latency communication. In the same manner, the technical requirements that are needed in order to realize the low latency communication do not include all technical requirements that are needed in order to realize the large capacity communication.

For this reason, a network for the 5G system is expected to be realized as a heterogeneous network in which communication systems (communication cells) that use various frequencies and radio access technologies are present in a mixed manner. With heterogenous network, one communication system does not need to satisfy all required conditions of the 5G system. Take, for example, what is described above. A communication system for realizing the large capacity communication and a communication system for realizing the low latency communication may be present in the heterogeneous network.

### CITATION LIST

### Non Patent Literature

NPL 1: ARIB White Paper, “Mobile communication systems for 2020 and beyond,” October 2014
NPL 2: NGMN White Paper, “NGMN 5G WHITE PAPER,” February 2015

### SUMMARY OF INVENTION

### Technical Problem

However, because there is a limitation on radio resources (a frequency, a time, and a space) that are used for wireless communication, in a case where a plurality of communication systems are present in the heterogeneous network, there is competition among the communication systems for the radio resource. For example, the communication system that realizes the large capacity communication uses a great number of radio resources. Consequently, in a case where the large capacity communication and the low latency communication are realized at the same time, the radio resources that are necessary for the low latency communication are no longer available. Thus, a desired communication service cannot be provided.

An object of the present invention, which was made in view of the situation described above, is to provide a communication system and a base station apparatus that efficiently provide a communication service that needs a plurality of different required conditions.

### Solution to Problem

In order to solve the described problem, constitutions of a communication system and a base station apparatus according to the present invention are as follows.

(1) That is, according to an aspect of the present invention, there is provided a communication system that includes a base station apparatus and a terminal apparatus and provides a communication service based on a plurality of communication modes that satisfy different communication qualities, in which the plurality of communication modes includes a first communication mode and a second communication mode, in which a communication route included in the first communication mode and a communication route included in the second communication mode are different from each other, and in which a trigger for the base station apparatus to start communication based on the second communication mode is included in information transmitted by the terminal apparatus in accordance with the first communication mode.

(2) Furthermore, the communication system according to the aspect of the present invention, which is the communication system described in (1), further includes a plurality of base station apparatuses, each of which is the base station apparatus, in which, among the plurality of base station apparatuses, the communication route included in the first communication mode is a communication path between a base station apparatus having the highest first communication quality and the terminal apparatus, and, among the plurality of base station apparatuses, the communication route included in the second communication mode is a communication path between a base station apparatus having the highest second communication quality and the terminal apparatus.

(3) Furthermore, in the communication system according to the aspect of the present invention, which is the communication system that is described in (2), the base station apparatus having the highest first communication quality is a base station apparatus having the highest reception quality of a signal from the terminal apparatus, and the base station apparatus having the highest second communication quality is a base station apparatus capable of securing a radio resource required between the base station apparatus itself and the terminal apparatus.

(4) Furthermore, in the communication system according to the aspect of the present invention, which is the communication system that is described in (3), a radio resource that is used for the second communication mode is determined based on a radio resource that is used for the first communication mode.

(5) Furthermore, in the communication system according to the aspect of the present invention, which is the communication system that is described in (1), the second communication mode is a communication mode including a beamforming transmission, and the base station apparatus performs the beamforming transmission in accordance with information that is transmitted by the terminal apparatus in accordance with the first communication mode.

(6) Furthermore, in the communication system according to the aspect of the present invention, which is the communication system that is described in (5), information acquired by the terminal apparatus in accordance with the first communication mode is surrounding information of the terminal apparatus, and the base station apparatus acquires positional information of the terminal apparatus in accordance with the surrounding information, and performs the beamforming transmission in accordance with the positional information.

(7) Furthermore, in the communication system according to the aspect of the present invention, which is the communication system that is described in any one of (2) to (4), in a case where the communication based on the second communication mode does not satisfy the required second communication quality, the base station apparatus performs signaling of information, which indicates that the communication based on the second communication mode does not satisfy the required second communication quality, to the terminal apparatus.

(8) Furthermore, in the communication system according to the aspect of the present invention, which is the communication system that is described in any one of (2) to (4), the first communication quality is a data rate and the second communication quality is a communication latency time.

(9) Furthermore, according to another aspect of the present invention, there is provided a base station apparatus that is included in a communication system which provides a communication service based on a plurality of communication modes that satisfy different communication qualities, and communicates with a terminal apparatus, in which the plurality of communication modes include a first communication mode and a second communication mode, in which the second communication mode is a communication mode including a beamforming transmission, in which the base station apparatus includes a transmission unit that performs the beamforming transmission, and in which the transmission unit performs the beamforming transmission in accordance with information that is transmitted by the terminal apparatus in accordance with the first communication mode.

### Advantageous Effects of Invention

According to an aspect of the present invention, there is provided a communication system and a base station apparatus that efficiently provide a communication service that needs a plurality of different required conditions. Thus, providing of a high-quality communication service is realized.

### BRIEF DESCRIPTION OF DRAWINGS

FIG. 1 is a schematic diagram illustrating an example of a communication system according to an aspect of the present invention.

FIG. 2 is a schematic block diagram illustrating an example of a constitution of a base station apparatus according to the aspect of the present invention.

FIG. 3 is a schematic block diagram illustrating an example of constitution of a terminal apparatus according to the aspect of the present invention.

FIG. 4 is a schematic diagram illustrating an example of the communication system according to the aspect of the present invention.

FIG. 5 is a schematic diagram illustrating an example of the communication system according to the aspect of the present invention.

### DESCRIPTION OF EMBODIMENTS

A communication system according to the present embodiment includes a base station apparatus (a transmission apparatus, a cell, a transmission point, a transmit antenna group, a transmit antenna port group, a component carrier, and an eNodeB) and a terminal apparatus (a terminal, a mobile terminal, a reception point, a reception terminal, a reception apparatus, a receive antenna group, a receive antenna port group, and a UE). It is noted that the base station apparatus may further include one or several of capabilities of the terminal apparatus. It is noted that the terminal apparatus may further include one or several of the capabilities of the base station apparatus.

In the present embodiment, the meaning “X/Y” includes the meaning of “X or Y”. In the present embodiment, the meaning “X/Y” includes the meaning of “X and Y”. In the present embodiment, the meaning “X/Y” includes the meaning of “X and/or Y”.

### 1. First Embodiment

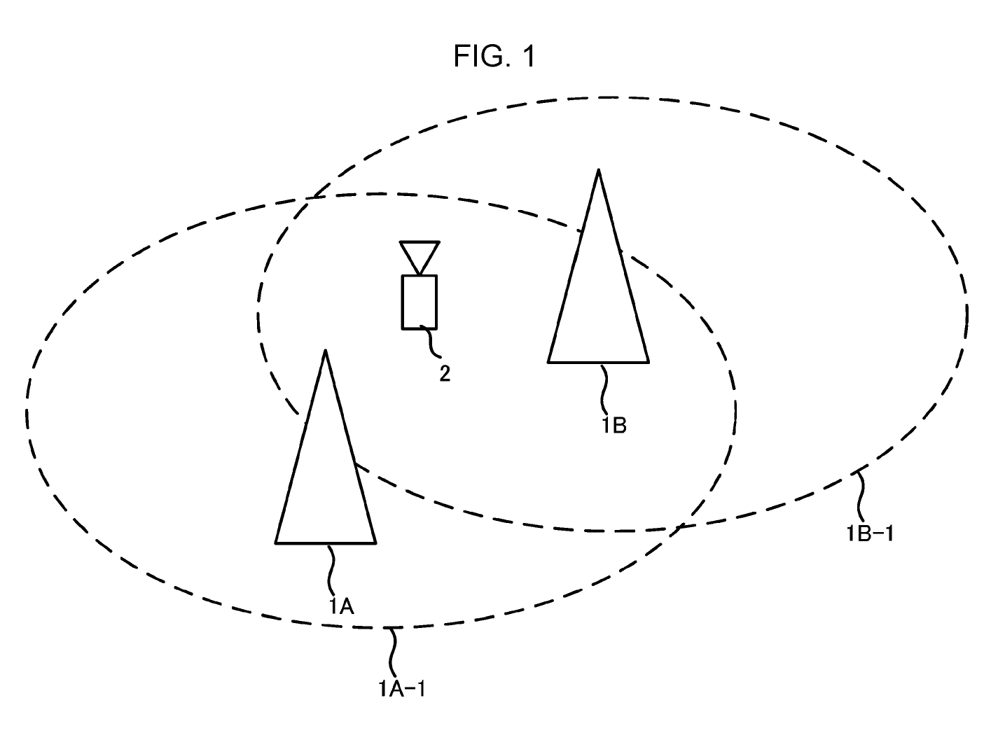

FIG. 1 is a diagram illustrating an example of the communication system according to the present embodiment. As illustrated in FIG. 1, the communication system according to the present embodiment includes a base station apparatus 1A, a base station apparatus 1B, and a terminal apparatus 2. Furthermore, coverage 1-1 is a range (a communication area) in which the base station apparatus 1A can make a connection to the terminal apparatus. It is noted that the base station apparatus 1A and the base station apparatus 1B are collectively also referred to as a base station apparatus 1.

At least one step of a communication method that will be described below is included in the base station apparatus 1A, the base station apparatus 1B, and the terminal apparatus 2 that are included in the communication system according to the present embodiment. Furthermore, the communication system according to the present embodiment may include a base station apparatus other than the base station apparatus 1A and the base station apparatus 1B and a terminal apparatus other than the terminal apparatus 2.

In FIG. 1, the following uplink physical channels are used for wireless communication for uplink from the terminal apparatus 2 to the base station apparatus 1. The uplink physical channels are used for transmitting information that is output from a higher layer.
Physical Uplink Control Channel (PUCCH)
Physical Uplink Shared Channel (PUSCH)
Physical Random Access Channel (PRACH)

The PUCCH is used for transmitting Uplink Control Information (UCI). At this point, the Uplink Control Information includes a positive acknowledgement (ACK) or a negative acknowledgement (NACK) (ACK/NACK) of downlink data (a downlink transport block or a Downlink-Shared Channel (DL-SCH)). The ACK/NACK of the downlink data is also referred to as a HARQ-ACK or HARQ feedback.

Furthermore, the Uplink Control Information includes Channel State Information (CSI) for a downlink. Furthermore, the Uplink Control Information includes a Scheduling Request (SR) that is used for making a request for a resource for Uplink-Shared Channel (UL-SCH). A Rank Indicator (RI) that designates the suitable number of spatial multiplexing, a Precoding Matrix Indicator (PMI) that designates suitable precoding, a Channel Quality Indicator (CQI) that designates a suitable transfer rate, and the like correspond to the Channel State Information.

The Channel Quality Indicator (CQI) (hereinafter referred to as a CQI value) can be defined as a suitable modulation scheme (for example, QPSK, 16 QAM, 64 QAM, 256 QAM, or the like) in a prescribed band (which will be in detail below) and a code rate. The CQI value can be defined as a CQI index that is determined by the modulation scheme and the code rate. The CQI value can be defined as being determined in advance in the system.

It is noted that the Rank Indicator and the Precoding Quality Indicator can be defined as being determined in advance in the system. The Rank Indicator and the Precoding Matrix Indicator can be defined as indexes that are determined in advance with the number of spatial multiplexing or the Precoding Matrix information. It is noted that values of the Rank Indicator, the Precoding Matrix Indicator, and the Channel Quality Indicator (CQI) are collectively referred as to the CSI value.

The PUSCH is used for transmitting uplink data (an uplink transport block or the UL-SCH). Furthermore, the PUSCH may be used for transmitting the ACK/NACK and/or the Channel State Information, along with the uplink data. Furthermore, the PUSCH may be used for transmitting only the Uplink Control Information.

Furthermore, the PUSCH is used for transmitting an RRC message. The RRC message is a piece of information/signal that is processed in a Radio Resource Control (RRC) layer. Furthermore, the PUSCH is used for transmitting a MAC Control Element (CE). At this point, the MAC CE is a piece of information/signal that is processed (transmitted) in a Medium Access Control (MAC) layer.

For example, a power headroom may be included in the MAC CE, and may be reported via the PUSCH. That is, a field in the MAC CE may be used for indicating a level of the power headroom.

The PRACH is used for transmitting a random access preamble.

Furthermore, in the uplink wireless communication for the uplink, an Uplink Reference Signal (UL RS) is used as an uplink physical signal. The uplink physical signal is not used for transmitting the information that is output from the higher layer, but is used by a physical layer. At this point, a Demodulation Reference Signal (DMRS) or a Sounding Reference Signal (SRS) are included in the Uplink Reference Signal.

The DMRS is associated with transmission of the PUSCH or the PUCCH. For example, the base station apparatus 1A uses the DMRS in order to perform channel reconfiguration of the PUSCH or the PUCCH. The SRS is not associated with transmission of the PUSCH or the PUCCH. For example, the base station apparatus 1A uses the SRS in order to measure an uplink channel state.

In FIG. 1, in wireless communication for the downlink from the base station apparatus 1A to the terminal apparatus 2, the following downlink physical channels are used. The downlink physical channels are used for transmitting the information that is output from the higher layer.
Physical Broadcast Channel (PBCH)
Physical Control Format Indicator Channel (PCFICH)
Physical Hybrid automatic repeat request Indicator
Channel (PHICH) (HARQ Indicator Channel)
Physical Downlink Control Channel (PDCCH)
Enhanced Physical Downlink Control Channel (EPDCCH)
Physical Downlink Shared Channel (PDSCH)

The PBCH is used for broadcasting a Master Information Block (MIB) (a Broadcast Channel (BCH)) that is used in a shared manner in the terminal apparatus. The PCFICH is used for transmitting information indicating a region (for example, the number of OFDM symbols) that is used for transmission of the PDCCH.

The PHICH is used for transmitting the ACK/NACK of the uplink data (the transport block or the codeword) that is received by the base station apparatus 1A. That is, the PHICH is used for transmitting a HARQ indicator (the HARQ feedback) indicating the ACK/NACK of the uplink data. Furthermore, the ACK/NACK is also referred to as a HARQ-ACK. The terminal apparatus 2 notifies the higher layer of the received ACK/NACK. The ACK/NACK is the ACK indicating that reception is correctly performed, the NACK indicating that reception is not correctly performed, and DTX indicating that corresponding data is not present. Furthermore, in a case where the PHICH for the uplink data is not present, the terminal apparatus 2 notifies the higher layer of the ACK.

The PDCCH and the EPDCCH are used for transmitting Downlink Control Information (DCI). At this point, a plurality of DCI formats are defined for transmission of the Downlink Control Information. That is, a field for the Downlink Control Information is defined in a DCI format and is mapped to an information bit.

For example, as the DCI format for the downlink, a DCI format 1A that is used for scheduling of one PDSCH (transmission of one downlink transport block) in one cell is defined.

For example, information relating to PDSCH resource allocation, information relating to a Modulation and Coding Scheme (MCS) for the PDSCH, and the Downlink Control Information such as a TPC command for the PUCCH are included in the DCI format for the downlink. At this point, the DCI format for the downlink is also referred to as a downlink grant (a downlink assignment).

Furthermore, for example, as the DCI format for the uplink, a DCI format 0 that is used for scheduling of one PUSCH (transmission of one uplink transport block) in one cell is defined.

For example, information relating to PUSCH resource allocation, information relating to an MCS for the PUSCH, and the Uplink Control Information such as a TPC command for the PUSCH are included in the DCI format for the uplink. At this point, the DCI format for the uplink is also referred to as an uplink grant (an uplink assignment).

Furthermore, the DCI format for the uplink can be used for making a request for the Channel State Information (CSI) (also referred to as reception quality information) (making a CSI request) for the downlink. The Rank Indicator (RI) that designates the suitable number of spatial multiplexing, the Precoding Matrix Indicator (PMI) that designates the suitable precoding, the Channel Quality Indicator (CQI) that designates the suitable transfer rate, a Precoding type Indicator (PTI), and the like correspond to the Channel State Information.

Furthermore, the DCI format for the uplink can be used for a configuration indicating an uplink resource to which a Channel State Information report (CSI feedback report) that the terminal apparatus feeds back to the base station apparatus is mapped. For example, the Channel State Information report can be used for a configuration indicating the uplink resource for periodically reporting the Channel State Information (Periodic CSI). The Channel State Information report can be used for configuring a mode (a CSI report mode) for periodically reporting the Channel State Information.

For example, the Channel State Information report can be used for a configuration indicating the uplink resource for aperiodically reporting the Channel State Information (Aperiodic CSI). The Channel State Information report can be used for configuring a mode (a CSI report mode) for aperiodically reporting the Channel State Information. The base station apparatus can configure either the periodic Channel State Information report or the aperiodic Channel State Information report. Furthermore, the base station apparatus can configure both the periodic Channel State Information report and the aperiodic Channel State Information report.

Furthermore, the DCI format for the uplink can be used for a configuration indicating a type of Channel State Information report that the terminal apparatus feeds back to the base station apparatus. There are wideband CSI (for example, Wideband CQI) subband CSI (for example, subband CQI) and the like as types of Channel State Information reports.

In a case where a resource for the PDSCH is scheduled using the downlink assignment, the terminal apparatus receives the downlink data on the scheduled PDSCH. Furthermore, in a case where a resource for the PUSCH is scheduled using the uplink grant, the terminal apparatus transmits the uplink data and/or the Uplink Control Information on the scheduled PUSCH.

The PDSCH is used for transmitting the downlink data (the downlink transport block or the DL-SCH). Furthermore, the PDSCH is used for transmitting a system information block type-1 message. The system information block type-1 message is cell-specific (cell-peculiar) information.

Furthermore, the PDSCH is used for transmitting a system information message. The system information message includes a system information block X other than a system information block type-1. The system information message is cell-specific (cell-peculiar) information.

Furthermore, the PUSCH is used for transmitting an RRC message. At this point, the RRC message that is transmitted from the base station apparatus may be common to a plurality of terminal apparatuses within a cell. Furthermore, the RRC message that is transmitted from the base station apparatus 1A may be a message (also referred to as dedicated signaling) dedicated to a certain terminal apparatus 2. That is, user apparatus-specific (user apparatus-peculiar) information is transmitted using the message dedicated to a certain terminal apparatus. Furthermore, the PDSCH is used for transmitting the MAC CE.

At this point, the RRC message and/or the MAC CE is also referred to as higher layer signaling.

Furthermore, the PDSCH can be used for making a request for the Channel State Information for the downlink. Furthermore, the PDSCH can be used for transmitting the uplink resource to which the Channel State Information report (the CSI feedback report) that the terminal apparatus feeds back to the base station apparatus is mapped. For example, the Channel State Information report can be used for a configuration indicating the uplink resource for periodically reporting the Channel State Information (Periodic CSI). The Channel State Information report can be used for configuring a mode (a CSI report mode) for aperiodically reporting the Channel State Information.

There are wideband CSI (for example, Wideband CSI) and subband CSI (for example, subband CSI) as types of Channel State Information reports for the downlink. Regarding the wideband CSI, one piece of Channel State Information is calculated for a system band of a cell. Regarding the subband CSI, the system band is segmented into prescribed sections, and one piece of Channel State Information is calculated for the section that results from the segment.

Furthermore, in the wireless communication for the downlink, a Synchronization signal (SS) and a Downlink Reference Signal (DL RS) are used as the downlink physical signals. The uplink physical signal is not used for transmitting the information that is output from the higher layer, but is used by the physical layer.

The synchronization signal is used in order for the terminal apparatus to be synchronized to a frequency domain and a time domain for the downlink. Furthermore, the Downlink Reference Signal is used in order for the terminal apparatus to perform the channel reconfiguration of the downlink physical channel. For example, the Downlink Reference Signal is used in order for the terminal apparatus to calculate the Channel State Information for the downlink.

At this point, a Cell-specific Reference Signal (CRS), a UE-specific Reference Signal (URS) associated with the PDSCH, a Demodulation Reference Signal (DMRS) associated with the EPDCCH, a Non-Zero Power Chanel State Information-Reference Signal (NZP CSI-RS), and a Zero Power Chanel State Information-Reference Signal (ZP CSI-RS) are included in the Downlink Reference Signal.

The CRS is transmitted in an entire band of a subframe, and is used for demodulation of the PBCH/PDCCH/PHICH/PCFICH/PDSCH. The URS associated with the PDSCH is transmitted in a subframe and a band that are used for transmission of the PDSCH with which the URS is associated, and is used for performing demodulation of the PDSCH with which the URS is associated.

The DMRS associated with the EPDCCH is transmitted in a subframe and a band that are used for transmission of the EPDCCH with which the DMRS is associated. The DMRS is used for performing demodulation of the EPDCCH with which the DMRS is associated.

A resource for the NZP CSI-RS is configured by the base station apparatus 1A. For example, the terminal apparatus 2 performs measurement (channel measurement) of a signal, using the NZP CSI-RS. A resource for the ZP CSI-RS is configured by the base station apparatus 1A. With a zero output, the base station apparatus 1A transmits the ZP CSI-RS. For example, the terminal apparatus 2 performs measurement of interference in a resource to which the NZP CSI-RS corresponds.

A Multimedia Broadcast multicast service Single Frequency Network (MBSFN) RS is transmitted in an entire band of a subframe that is used for transmission of a PMCH. The MBSFN RS is used for performing demodulation of the PMCH. The PMCH is transmitted in an antenna port that is used for transmission of the MBSFN RS.

At this point, the downlink physical channel and the downlink physical signal are collectively also referred to as a downlink signal. Furthermore, the uplink physical channel and the uplink physical signal are collectively also referred to as an uplink signal. Furthermore, the downlink physical channel and the uplink physical channel are also collectively referred to as the physical channel. Furthermore, the downlink physical signal and the uplink physical signal are collectively also referred to as a physical signal.

Furthermore, the BCH, the UL-SCH, and the DL-SCH are the transport channels. A channel that is used in the MAC layer is referred to as the transport channel. Furthermore, a unit for the transport channel that is used in the MAC layer is also referred to as a Transport block (TB) or a MAC Protocol Data Unit (PDU). The transport block is a unit for data that is delivered by the MAC layer to the physical layer. In the physical layer, the transport block is mapped to the codeword, and coding processing or the like is performed for every codeword.

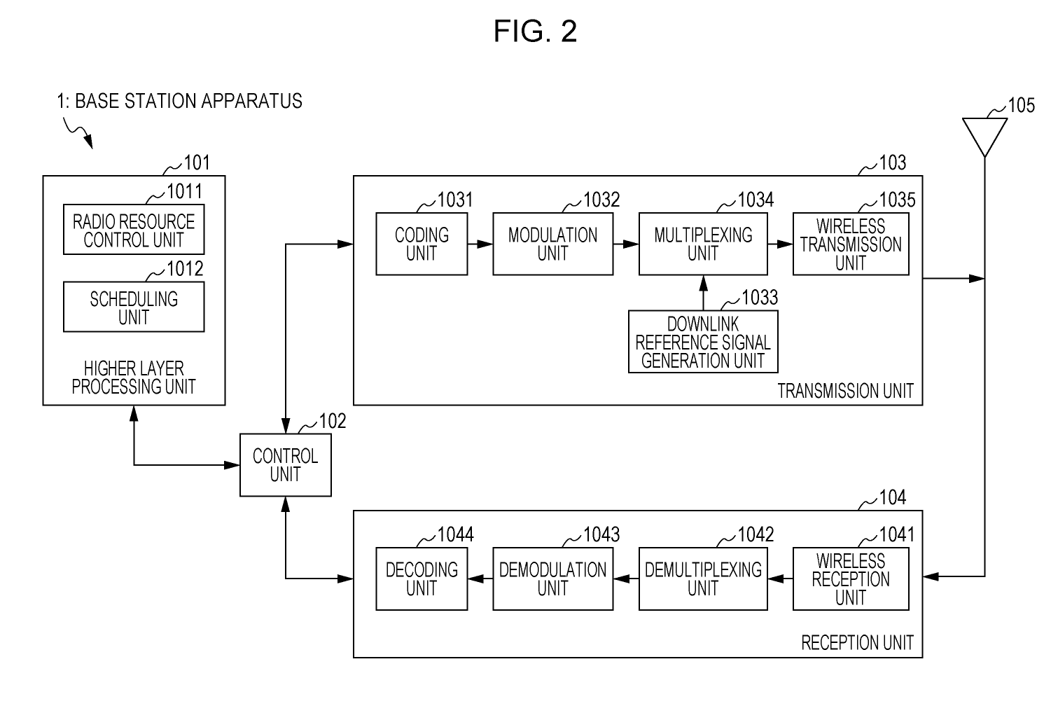

FIG. 2 is a schematic block diagram illustrating a constitution of the base station apparatus 1A according to the present embodiment. As illustrated in FIG. 2, the base station apparatus 1A is constituted to include a higher layer processing unit (a higher layer processing step) 101, a control unit (a control step) 102, a transmission unit (a transmission step) 103, a reception unit (a reception step) 104, and a transmit and receive antenna 105. Furthermore, the higher layer processing unit 101 is constituted to include a Radio Resource Control unit (a Radio Resource Control step) 1011, and a scheduling unit (a scheduling step) 1012. Furthermore, the transmission unit 103 is constituted to include a coding unit (a coding step) 1031, a modulation unit (a modulation step) 1032, a Downlink Reference Signal generation unit (a Downlink Reference Signal generation step) 1033, a multiplexing unit (a multiplexing step) 1034, and a wireless transmission unit (a wireless transmission step) 1035. Furthermore, the reception unit 104 is constituted to include a wireless reception unit (a wireless reception step) 1041, a demultiplexing unit (a demultiplexing step) 1042, a demodulation unit (a demodulation step) 1043, and a decoding unit (a decoding step) 1044.

Furthermore, the higher layer processing unit 101 performs processing of the Medium Access Control (MAC) layer, a Packet Data Convergence Protocol (PDCP) layer, a Radio Link Control (RLC) layer, and a Radio Resource Control (RRC) layer. Furthermore, the higher layer processing unit 101 generates information necessary for performing control of the transmission unit 103 and the reception unit 104, and outputs the generated information to the control unit 102.

The higher layer processing unit 101 receives information relating to the terminal apparatus, such as the UE capability, from the terminal apparatus. In other words, the terminal apparatus transmits its own capability to the base station apparatus using the higher layer signaling.

It is noted that in the following description, the information relating to the terminal apparatus includes information indicating whether or not the terminal apparatus supports a prescribed capability, or information indicating whether or not the terminal apparatus finishes introduction and testing of the prescribed capability. It is noted that in the following description, whether or not the prescribed capability is supported includes whether or not the introduction of the testing of the prescribed function is finished.

For example, in a case where the terminal apparatus supports the prescribed capability, the terminal apparatus transmits information (a parameter) indicating whether or not the prescribed capability is supported. In a case where the terminal apparatus does not support the prescribed capability, the terminal apparatus does not transmit the information (the parameter) indicating whether or not the prescribed capability is supported. That is, notification of whether or not the prescribed capability is supported depends on whether or not the information (the parameter) indicating whether or not the prescribed capability is supported is transmitted. It is noted that the information (the parameter) indicating whether or not the prescribed capability is supported may be notified using a bit of 1 or a bit of 0.

The Radio Resource Control unit 1011 generates, or acquires from a higher node, the downlink data (the transport block), system information, the RRC message, the MAC CE, and the like, which are mapped to the PDSCH for the downlink. The Radio Resource Control unit 1011 outputs the downlink data to the transmission unit 103 and outputs the other pieces of information to the control unit 102. Furthermore, the Radio Resource Control unit 1011 manages various pieces of configuration information of the terminal apparatus.

The scheduling unit 1012 determines a frequency and a subframe to which the physical channel (the PDSCH and the PUSCH) is allocated, a code rate and a modulation scheme (or an MCS), a transmit power for the physical channel (the PDSCH and the PUSCH), and the like. The scheduling unit 1012 outputs the determined information to the control unit 102.

Based on a result of the scheduling, the scheduling unit 1012 generates information that is used for the scheduling of the physical channels (the PDSCH and the PUSCH). The scheduling unit 1012 outputs the generated information to the control unit 102.

Based on information that is input from the higher layer processing unit 101, the control unit 102 generates a control signal that performs the control of the transmission unit 103 and the reception unit 104. The control unit 102 generates the Downlink Control Information based on the information that is input from the higher layer processing unit 101, and outputs the generated Downlink Control Information to the transmission unit 103.

The transmission unit 103 generates the Downlink Reference Signal in accordance with the control signal that is input from the control unit 102, codes and modulates the HARQ indicator, the Downlink Control Information, and the downlink data, which are input from the higher layer processing unit 101, multiplexes the PHICH, the PDCCH, the EPDCCH, the PDSCH, and the Downlink Reference Signal, and transmits the resulting signal to the terminal apparatus 2 through the transmit and receive antenna 105.

The coding unit 1031 performs coding on the HARQ indicator, the Downlink Control Information, and the downlink data, which are input from the higher layer processing unit 101. When performing the coding, the coding unit 1031 uses a coding scheme that is determined in advance, such as block coding, convolutional coding, or turbo coding, or uses a coding scheme that is determined by the radio resource control unit 1011. The modulation unit 1032 performs modulation on coding bits that are input from the coding unit 1031, using a modulation scheme that is determined in advance, such as Binary Phase Shift Keying (BPSK), quadrature Phase Shift Keying (QPSK), 16 quadrature amplitude modulation (QAM), 64 QAM, or 256 QAM, or using a modulation scheme that is determined by the radio resource control unit 1011.

The downlink reference signal generation unit 1033 generates as the Downlink Reference Signal a sequence that is already known to the terminal apparatus 2, which is obtained according to a rule that is determined in advance based on a physical cell identity (PCI) (or a cell ID) for identifying the base station apparatus 1A, and the like.

The multiplexing unit 1034 multiplexes a modulation symbol of each channel, which results from the modulation, and the Downlink Reference Signal and the Downlink Control Information, which are generated. More precisely, the multiplexing unit 1034 maps the modulation symbol of each channel that results from the modulation and the Downlink Reference Signal and the Downlink Control Information, which are generated, to resource elements.

The wireless transmission unit 1035 performs Inverse Fast Fourier Transform (IFFT) on a modulation symbol and the like that result from the multiplexing, generates an OFDM symbol, adds a cyclic prefix (CP) to the generated OFDM symbol, generates a digital signal in a baseband, converts the digital signal in the baseband into an analog signal, removes a superfluous frequency component by perform filtering, performs up-converting into a carrier frequency, performs power amplification, and outputs a final result to the transmit and receive antenna 105 for transmission.

In accordance with the control signal that is input from the control unit 102, the reception unit 104 demultiplexes, demodulates, and decodes a reception signal that is received from the terminal apparatus 2 through the transmit and receive antenna 105, and outputs information that results from the decoding, to the higher layer processing unit 101.

The wireless reception unit 1041 converts an uplink signal that is received through the transmit and receive antenna 105 into a signal in a baseband by performing down-converting, removes an unnecessary frequency component, controls an amplification level in such a manner that a signal level is suitably maintained, performs orthogonal demodulation based on an in-phase component and an quadrature component of the received signal, and converts the analog signal that results from the orthogonal demodulation, into a digital signal.

The wireless reception unit 1041 removes a portion that is equivalent to the CP from the digital signal that results from the conversion. The wireless reception unit 1041 performs Fast Fourier Transform (FFT) on the signal from which the CP is removed, extracts a signal in the frequency domain, and outputs the extracted signal to the demultiplexing unit 1042.

The demultiplexing unit 1042 demultiplexes the signal that is input from the wireless reception unit 1041, into the PUCCH, the PUSCH, the Uplink Reference Signal, and the like. It is noted that the demultiplexing is performed based on radio resource allocation information that is determined in advance by the base station apparatus 1A, using the radio resource control unit 1011, and that is included in the uplink grant which is notified to each terminal apparatus 2.

Furthermore, the demultiplexing unit 1042 performs channel compensation on channels, that is, the PUCCH and the PUSCH. Furthermore, the demultiplexing unit 1042 demultiplexes the Uplink Reference Signal.

The demodulation unit 1043 performs Inverse Discrete Fourier Transform (IDFT) on the PUSCH, acquires a modulation symbol, and performs reception signal demodulation on each of the modulation symbols of the PUCCH and the PUSCH, using the modulation scheme that is determined in advance, such as BPSK, QPSK, 16 QAM, 64 QAM, or 256 QAM, or using the modulation scheme that is notified in advance with the uplink grant, to each terminal apparatus 2 by the base station apparatus 1A itself.

The decoding unit 1044 performs the decoding on coding bits of the PUCCH and the PUSCH that result from the demodulation, at a code rate in compliance with the coding scheme that is determined in advance, which is determined in advance, or at a code rate which is notified in advance with the uplink grant to the terminal apparatus 2 by the base station apparatus 1A itself, and outputs the uplink data and the Uplink Control Information that result from the decoding, to the higher layer processing unit 101. In the case of retransmission of the PUSCH, the decoding unit 1044 performs the decoding using the coding bits that are input from the higher layer processing unit 101 and that are retained in an HARQ buffer, and the coding bits that result from the demodulation.

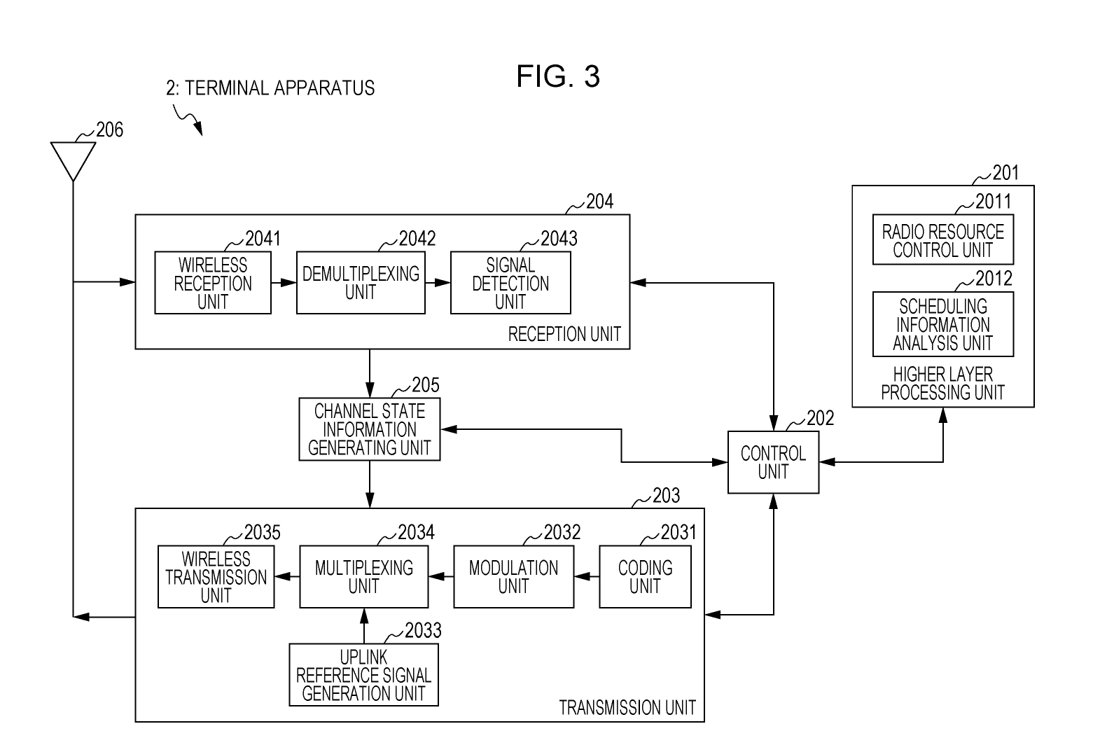

FIG. 3 is a schematic block diagram illustrating a constitution of the terminal apparatus 2 according to the present embodiment. As illustrated in FIG. 3, the terminal apparatus 2 is constituted to include a higher layer processing unit (a higher layer processing step) 201, a control unit (a control step) 202, a transmission unit (a transmission step) 203, a reception unit (a reception step) 204, a Channel State Information generating unit (a Channel State Information generation step) 205, and a transmit and receive antenna 206. Furthermore, the higher layer processing unit 201 is constituted to include a Radio Resource Control unit (a Radio Resource Control step) 2011, and a scheduling information analysis unit (a scheduling information analysis step) 2012. Furthermore, the transmission unit 203 is constituted to include a coding unit (a coding step) 2031, a modulation unit (a modulation step) 2032, an Uplink Reference Signal generation unit (an Uplink Reference Signal generation step) 2033, a multiplexing unit (a multiplexing step) 2034, and a wireless transmission unit (a wireless transmission step) 2035.

Furthermore, the reception unit 204 is constituted to include a wireless reception unit (a wireless reception step) 2041, a demultiplexing unit (a demultiplexing step) 2042, and a signal detection unit (a signal detection step) 2043.

The higher layer processing unit 201 outputs the uplink data (the Transport Block) that is generated by a user operation and the like, to the transmission unit 203. Furthermore, the higher layer processing unit 201 performs the processing of the Medium Access Control (MAC) layer, the Packet Data Convergence Protocol (PDCP) layer, the Radio Link Control (RLC) layer, and the Radio Resource Control (RRC) layer.

The higher layer processing unit 201 outputs information indicating the UE capability that is supported by the terminal apparatus 2 itself, to the transmission unit 203.

The Radio Resource Control unit 2011 manages various pieces of configuration information of the terminal apparatus 2 itself. Furthermore, the Radio Resource Control unit 2011 generates information that is mapped to each channel for the uplink, and outputs the generated information to the transmission unit 203.

The Radio Resource Control unit 2011 acquires configuration information relating to CSI feedback, which is transmitted from the base station apparatus, and outputs the acquired configuration information to the control unit 202.

The scheduling information analysis unit 2012 analyzes the Downlink Control Information that is received through the reception unit 204, and determines scheduling information. Furthermore, the scheduling information analysis unit 2012 generates control information in order to perform control of the reception unit 204 and the transmission unit 203, based on the scheduling information, and outputs the generated control information to the control unit 202.

Based on information that is input from the higher layer processing unit 201, the control unit 202 generates a control signal that performs control of the reception unit 204, the Channel State Information generating unit 205, and the transmission unit 203. The control unit 202 outputs the generated control signal to the reception unit 204, the Channel State Information generating unit 205, and the transmission unit 203, and performs the control of the reception unit 204 and the transmission unit 203.

The control unit 202 controls the transmission unit 203 in such a manner that the CSI which is generated by the Channel State Information generating unit 205 is transmitted to the base station apparatus.

In accordance with the control signal that is input from the control unit 202, the reception unit 204 demultiplexes, demodulates, and decodes a reception signal that is received from the base station apparatus 1A through the transmit and receive antenna 206, and outputs information that results from the decoding, to the higher layer processing unit 201.

The wireless reception unit 2041 converts a downlink signal that is received through the transmit and receive antenna 206 into a signal in a baseband by performing down-converting, removes an unnecessary frequency component, controls an amplification level in such a manner that a signal level is suitably maintained, performs orthogonal demodulation based on an in-phase component and an quadrature component of the received signal, and converts the analog signal that results from the orthogonal demodulation, into a digital signal.

Furthermore, the wireless reception unit 2041 removes a portion that is equivalent to the CP from the digital signal that results from the conversion, performs Fast Fourier Transform on the signal from which the CP is removed, and extracts a signal in the frequency domain.

The demultiplexing unit 2042 demultiplexes the extracted signal into the PHICH, the PDCCH, the EPDCCH, the PDSCH, and the Downlink Reference Signal. Furthermore, the demultiplexing unit 2042 performs the channel compensation on the PHICH, the PDCCH, and the EPDCCH based on a channel estimate of a desired signal that is acquired from channel measurement, detects the Downlink Control Information, and outputs the detected Downlink Control Information to the control unit 202. Furthermore, the control unit 202 outputs the PDSCH and a channel estimate of the desired signal to the signal detection unit 2043.

The signal detection unit 2043 detects a signal using the PDSCH and the channel estimate, and outputs the detected signal to the higher layer processing unit 201.

The transmission unit 203 generates the Uplink Reference Signal in accordance with the control signal, which is input from the control unit 202, codes and modulates the uplink data (the Transport Block), which is input from the higher layer processing unit 201, multiplexes the PUCCH, the PUSCH, and the generated Uplink Reference Signal, and transmits a result of the multiplexing to the base station apparatus 1A through the transmit and receive antenna 206.

The coding unit 2031 performs the coding, such as the convolutional coding or the block coding, on the Uplink Control Information that is input from the higher layer processing unit 201. Furthermore, the coding unit 2031 performs the turbo coding, based on information that is used for scheduling of the PUSCH.

The modulation unit 2032 performs the modulation on coding bits, which are input from the coding unit 2031, in compliance with a modulation scheme that is notified with the Downlink Control Information, such as BPSK, QPSK, 16 QAM, or 64 QAM, or in compliance with a modulation scheme that is determined in advance for every channel.

The Uplink Reference Signal generation unit 2033 generates a sequence that is acquired according to a rule (an equation) that is determined in advance, based on a physical cell identity (PCI) (referred to as a cell ID or the like) for identifying the base station apparatus 1A, a bandwidth to which the Uplink Reference Signal is mapped, a cyclic shift that is notified with the uplink grant, a value of a parameter for generation of a DMRS sequence, and the like.

In accordance with the control signal that is input from the control unit 202, the multiplexing unit 2034 remaps the modulation symbol of the PUSCH in parallel and then performs Discrete Fourier Transform (DFT) on the resulting modulation symbols. Furthermore, the multiplexing unit 2034 multiplexes PUCCH and PUSCH signals and the generated Uplink Reference Signal for every transmit antenna port. More precisely, the multiplexing unit 2034 maps the PUCCH and PUSCH signals and the generated Uplink Reference Signal to resource elements for every transmit antenna port.

The wireless transmission unit 2035 performs Inverse Fast Fourier Transform (IFFT) on a signal that results from the multiplexing, performs modulation in compliance with an SC-FDMA scheme on the resulting signal, generates an SC-FDMA symbol, adds a CP to the generated SC-FDMA symbol, generates a digital signal in a base band, converts the digital signal in the base band into an analog signal, removes superfluous frequency components, performs up-converting into a carrier frequency, performs power amplification, and outputs a final result to the transmit and receive antenna 206 for transmission.

It is noted that a communication method that is included in the base station apparatus 1 and the terminal apparatus 2 that are included in the communication system according to the present embodiment is not limited to the method described above. The base station apparatus 1 and the terminal apparatus 2 that are included in the communication system according to the present embodiment, for example, may support Long Term Evolution (LTE), and may support a communication scheme that is defined as IEEE 802.11.

The terminal apparatus 2 according to the present embodiment performs communication between the base station apparatus 1A and the base station apparatus 1B. Then, the terminal apparatus 2 performs a plurality of communications, each of which needs to satisfy a first communication quality and a second communication quality that are different from each other, between the base station apparatus 1A and the base station apparatus 1B. For example, in order for the terminal apparatus 2 to transmit data that contains a large amount of information to the base station apparatus 1, the terminal apparatus 2 and the base station apparatus 1 perform communication that satisfies a required data rate. Moreover, in order for the base station apparatus 1 to transmit a signal to the terminal apparatus 2 without causing much latency, the terminal apparatus 2 and the base station apparatus 1 perform communication that satisfies a required communication latency time. In this case, the first communication quality is a data rate, and the second communication quality is a communication latency time.

In the communication system according to the present embodiment, it is possible that communication that satisfies a required data rate and communication that satisfies a required latency time are performed at the same time. However, when the communication that satisfies the required latency time is started depends on the communication that satisfies the required data rate. For example, a trigger to start the communication that satisfies the required latency time can be based on information that is provided by the communication that satisfies the required data rate.

At this point, the data rate is defined as referring to an amount of information (the number of information bits) that is transmitted from a transmission apparatus to a reception apparatus within a fixed period of time. For example, in order for the terminal apparatus 2 to transmit a high-resolution moving image acquired by a camera device that is included in the terminal apparatus 2, in real time to the base station apparatus 1, a high data rate is required for the communication between the terminal apparatus 2 and the base station apparatus 1. Furthermore, in order for the terminal apparatus 2 to always transmit the moving image acquired by the terminal apparatus 2 at a high resolution to the base station apparatus 1, it is required that data rate is stable and thus that fixed can be realized. That is, in the communication that satisfies the required data rate according to the present embodiment, an averagely-high data rate is not realized, but a fixed high data rate can always be realized.

On the other hand, low latency communication refers to communication in which, after a transmission request (traffic) that is destined for another terminal apparatus occurs in a certain terminal apparatus, the time it takes for communication relating to the transmission request to be actually ended is short. Furthermore, the low latency communication can refer to communication in which, after a transmission request that is destined for another terminal apparatus occurs in a certain terminal apparatus, the time it takes for communication relating to the transmission request to be actually started is short. In the communication system according to the present embodiment, in a case where the time it takes for the communication to be actually started after the transmission request occurs in the terminal apparatus and the time it takes for the communication to be actually started after the transmission request occurs in the base station apparatus are compared with each other, the latter can be shorter than the former.

Furthermore, the communication latency time according to the present embodiment includes a control latency within one apparatus among all apparatuses (for example, the terminal apparatus, the base station apparatus, a Remote Radio Head, a Base Band Unit, and the like) that are present until the terminal apparatus that transmits information or makes a request for information finishes transmitting information to a target terminal apparatus or acquires information for which the terminal apparatus makes a request to the target terminal (End-to-End), and a communication latency between a wireless communication section and a wired communication section. The control latency within the apparatus according to the present embodiment includes the time relating to transmission and reception of information between protocols that are defined in the OSI reference model or the TCP/IP model. In the present embodiment, a state where a certain communication has a lower latency than another communication refers to the fact that any one of the latency times described above or the sum of a plurality of latency times is short (low).

Generally, a radio resource or a wireless technology that is required to satisfy the communication at a high data rate is different from a radio resource or a wireless technology, respectively, that is required to satisfy the communication with a low latency. Consequently, in a case where the communication system according to the present embodiment makes an attempt to satisfy the two communications described above using one communication method, the cost (the capital cost (APEX) that is represented by a radio resource, an apparatus manufacturing cost, and the like and the operating cost (OPEX) that is represented by system operating) relating to the communication are caused to increase.

Accordingly, the communication system according to the present embodiment can include a plurality of communication routes (communication paths), a communication scheme, and a radio access technology (RAT). For example, the communication system can include a first communication route (communication path) between the terminal apparatus 2 and the base station apparatus 1A, and a second communication route between the terminal apparatus 2 and the base station apparatus 1B. Furthermore, the communication system can perform a communication that uses a first communication scheme and a second communication scheme between the terminal apparatus 2 and the base station apparatus 1A. Furthermore, the communication system can cause the terminal apparatus 2 and the base station apparatus 1A to include a first RAT and a second RAT, respectively.

Furthermore, the communication system can include a plurality of communication modes that result from combining the communication schemes and the radio access technologies, which are described. For example, the terminal apparatus 2 can use the first RAT along the first communication route between the terminal apparatus 2 itself and the base station apparatus 1A, as a first communication mode, and on the other hand, can use the second RAT along the second communication route between the terminal apparatus 2 itself and the base station apparatus 1B, as a second communication mode. It is noted that in the present embodiment, an element that is included in the communication mode (that characterizes the communication mode) is not limited to what is described above and that another constituent element may be present and the element may be characterized by a required condition that will be described below. In the present embodiment, the communication system is described as including a plurality of communication modes as follows.

When the terminal apparatus 2 transmits a signal that makes a request for the communication at the high data rate, to the base station apparatus 1, the communication system according to the present embodiment can select the communication mode that is suitable for satisfying the request. It is noted that in the following description, the communication system itself may perform an operation of “selecting the communication mode”, and that the terminal apparatus 2 itself or the base station apparatus 1 itself may perform the operation. Furthermore, another apparatus (for example, Radio Network Controller (RNC)) that itself manages the communication system may perform the operation. Furthermore, an entity that itself provides a primary service using the communication system according to the embodiment may perform the operation.

Furthermore, an entity that itself selects the communication mode may differ from one communication to another. For example, in the communication system according to the present embodiment, it is possible that an entity which itself selects the first communication mode is the terminal apparatus 2, and that an entity which itself selects the second communication mode is defined as the base station apparatus 1.

Furthermore, the operations of selecting the communication mode, as will be described below, include an operation of selecting an element (a communication route, a communication scheme, a RAT, a radio frequency, a radio resource, and the like) that constitutes the communication mode, as well.

It is noted that the communication system according to the present embodiment can include a plurality of base station apparatuses. However, it is noted that it is also possible that, in a case where one base station apparatus is capable of supporting a plurality of communication modes, reference is made to a plurality of communication modes of the base station apparatus to define a plurality of base station apparatuses. For example, in the communication system according to the present embodiment, in a case where the base station apparatus 1A includes the first RAT and the second RAT, the base station apparatus 1A that uses the first RAT and the base station apparatus 1A that uses the second RAT can be regarded as being different base station apparatus 1A.

For example, when it comes to the base station apparatus 1A and the base station apparatus 1B, the terminal apparatus 2 can select a communication mode that uses a communication route between the terminal apparatus 2 itself and the base station apparatus 1 that has the highest reception quality, as the first communication mode that realizes the communication at a high data rate. This is because, with the first communication mode, a reception quality of a signal that is communicated using the first communication mode may be maintained at a high level. On the other hand, when it comes to the base station apparatus 1A and the base station apparatus 1B, the terminal apparatus 2 can select a communication mode that uses a communication route between the terminal apparatus 2 itself and the base station apparatus 1 capable of securing a radio resource, as the second communication mode that realizes the communication that has a low latency time. At this time, when selecting the second communication mode, the terminal apparatus 2 does not necessarily need to consider a reception quality.

As described above, the selection of the first communication mode and the second communication mode by the communication system can increase the data rate, which is the first communication quality, more with the first communication mode than with the second communication mode. On the other hand, the required latency time, which is the second communication quality, can be decreased more with the second communication mode than with the first communication mode.

Furthermore, the communication system according to the present embodiment, can select the first communication mode and the second communication mode according to the communication scheme that the base station apparatus 1 may support the RAT, the radio frequency, the communication bandwidth, or the like.

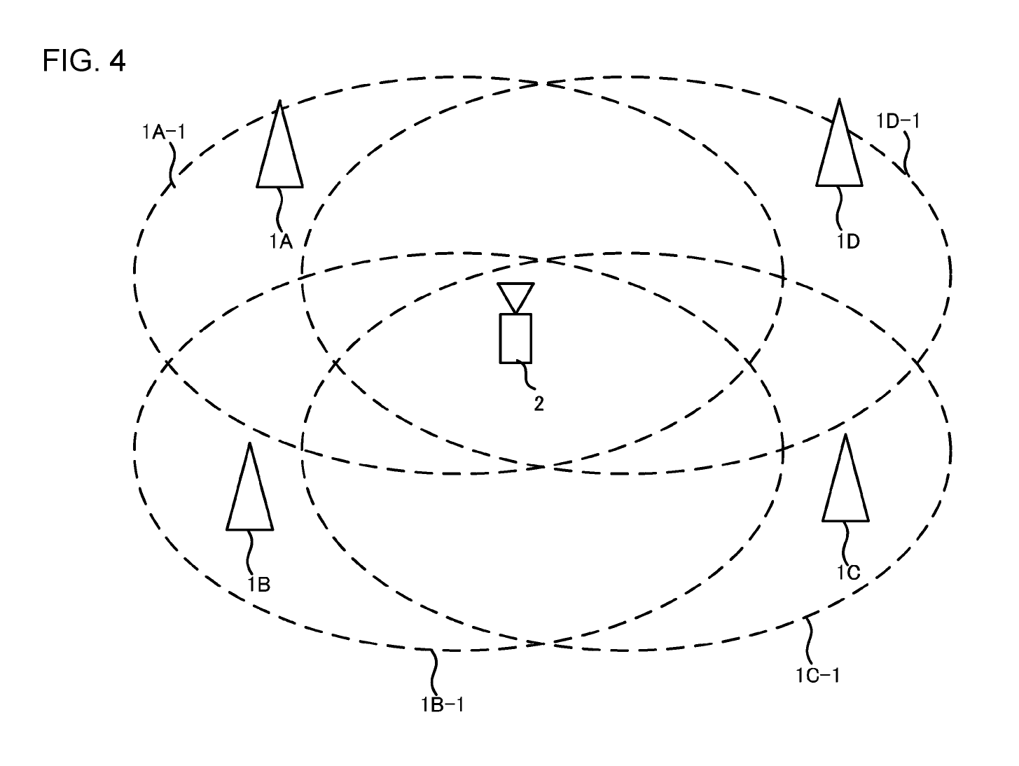

FIG. 4 is a diagram illustrating an example of an aspect of the communication system according to the present embodiment. The terminal apparatus 2 can select the base station apparatus 1 that has the highest reception quality, from among the base station apparatuses 1A to 1D that are included in the communication system, as the base station apparatus 1 that performs communication based on the first communication mode. On the other hand, when a signal is transmitted to the terminal apparatus 2 based on the second communication mode, the communication system according to the present embodiment selects the base station apparatus 1 capable of securing a radio resource at the instant the transmission request occurs, and the base station apparatus 1 can transmit a signal to the terminal apparatus 2 based on the second communication mode.

Of course, each time the terminal apparatus 2 moves within the communication system, the base station apparatus 1 with which the terminal apparatus 2 performs the communication based on the first communication mode and the second communication mode may be changed. Furthermore, the terminal apparatus 2 may perform the communication between the terminal apparatus 2 and each of the plurality of base station apparatuses 1, based on the first communication mode and the second communication mode. For example, in the communication system according to the present embodiment, in a case where a trigger for the communication that is based on the second communication mode occurs, all base station apparatuses 1 capable of securing a radio resource at the instant the trigger occurs may transmit the information to the terminal apparatus 2 based on the second communication mode.

In other words, it can be said that, in the communication system according to the present embodiment, the terminal apparatus 2 selects the base station apparatus 1 to which the terminal apparatus 2 itself is to make a connection, based on the communication mode that is used when the terminal apparatus 2 itself transmits information. That is, the terminal apparatus 2 can maintain a state of being connected to a plurality of base station apparatuses 1, but, as described so far above, it is possible that the plurality of base station apparatuses 1 are segregated into the base station apparatus 1 that performs the communication based on the first communication mode and the base station apparatus 1 that performs the communication that is based on the second communication mode.

This also holds true for a case where a service providing entity that provides a communication service based on the communication system according to the present embodiment selects the base station apparatus 1 to which the terminal apparatus 2 makes a connection. When it comes to the service providing entity, the base station apparatuses 1 that are included in the communication system which is included in the service providing entity are segregated into the base station apparatus 1 capable of performing the communication based on the first communication mode described so far above and the base station apparatus 1 capable of performing the communication based on the second communication mode. The service providing entity can select the base station apparatus 1 to which the terminal apparatus 2 makes a connection, according to a result of the segregation.

The segregation of the base station apparatuses 1, which is to be performed by the service providing entity, the terminal apparatus 2, and the base station apparatus 1, may be performed based on a momentary communication quality, and may be performed based on an average communication quality. Take, for example, what is described above. It can be said that the terminal apparatus 2 segregates the base station apparatus 1 that has a high reception quality which is given as a momentary communication quality, as the base station apparatus 1 capable of performing the communication based on the first communication mode. Furthermore, it can be said that the terminal apparatus 2 separates the base station apparatus 1 capable of securing a radio resource as the base station apparatus 1 capable of performing the communication based on the second communication mode.

It is noted that in the communication system according to the present embodiment, radio resources that are to be used by the first communication mode and the second communication mode are not limited to any one of the first and second communication modes, but that preferential allocation of the radio resource to the first communication mode that is desired to always maintain a high data rate is suitable. Consequently, in the communication system according to the present embodiment, the terminal apparatus 2 that is present in the communication system can determine the allocation of the radio resource in such a manner that the first communication mode may be realized, by making a connection to any one of the base station apparatuses 1 within the communication system. Among available radio resources, the communication system may allocate a radio resource that is not allocated to the first communication mode, to the second communication mode.

The communication system according to the present invention can allocate a radio resource fixedly to the first communication mode and the second communication mode. In this case, the base station apparatus 1 that provides the first communication mode and the base station apparatus 1 that provides the second communication mode are fixedly segregated.

The communication system according to the present embodiment can dynamically allocate a radio resource to the first communication mode and the second communication mode. In this case, according to available radio resources, a plurality of base station apparatuses 1 that are included in the communication system are segregated into the base station apparatus 1 that provides the first communication mode and the base station apparatus 1 that provides the second communication mode.

Furthermore, the communication system according to the present embodiment can group in advance combinations of the communication routes, the communication schemes, and the RATs that satisfy the first communication mode and the second communication mode. A plurality of combinations of the communication routes and the like that satisfy the first communication mode and the second communication mode may be available.

With the method described so far above, the communication system can effectively perform a plurality of communications that have different required conditions. Because of this, it is possible that a high-quality communication service is provided while greatly reducing the cost relating to the communication.

### 2. Second Embodiment

In the present embodiment, a plurality of communication modes that are included in the communication system are associated with each other. In the following, in the same manner as in the first embodiment, the communication system includes the first communication mode that satisfies the communication at a high data rate and the second communication mode that satisfies the communication that has a low latency.

In the first embodiment, first information that is transmitted by the terminal apparatus 2 using the first communication mode, and second information that is received by the terminal apparatus 2 using the second communication mode are associated with each other. For example, in the communication system according to the present embodiment, the first information that is transmitted by the terminal apparatus 2 using the first communication mode is surrounding information of the terminal apparatus 2 that is obtained by the terminal apparatus 2 itself using a device which is included in the terminal apparatus 2 itself. The surrounding information of the terminal apparatus 2 itself may be a still image or a moving image of surroundings, which is obtained by the terminal apparatus 2 using a camera device, and may be environmental data of surroundings, which is obtained by the terminal apparatus 2 using a sensor device. On the other hand, the second information that is received by the terminal apparatus 2 using the second communication mode is generated based on the surrounding information of the terminal apparatus 2 that is transmitted by the terminal apparatus 2 using the first communication mode. For example, in a case where specific information is contained in a moving image that is transmitted by the terminal apparatus 2 using the first communication mode, the communication system can transmit the second information to terminal apparatus 2 using the second communication mode. That is, in the same manner as in the first embodiment, it is determined whether or not the second information is transmitted using the second communication mode, based on the information that is transmitted using the first communication mode.

At this time, the communication system according to the present embodiment can use a specific communication technology in order to realize the second communication mode that needs to satisfy the low latency. For example, in order to realize the second communication mode, the communication system according to the present embodiment can use a beamforming technology (a beamforming transmission or a beamforming communication). Specifically, the base station apparatus 1 that is included in the communication system according to the present embodiment includes a plurality of transmit antennas, and can apply beamforming on a signal that is to be transmitted by the base station apparatus 1 itself and can transmit the resulting signal.

A beamforming transmission method according to the present embodiment is not limited to any beaming transmission method. For example, the base station apparatus 1 can perform digital beamforming that multiplies a transmission weighting, on a transmission signal in a baseband, which is destined for the terminal apparatus 2. Furthermore, the base station apparatus 1 adjusts a difference in phase or amplitude between each of the plurality of the antenna elements that are included in the base station apparatus 1, and thus can perform analog beamforming that performs the beamforming transmission. Furthermore, the base station apparatus 1 regards an antenna element group (a subarray) to which the analog beamforming is applied, as an apparent transmit antenna, and can perform hybrid beamforming that performs digital beamforming. Furthermore, the base station apparatus 1 includes a plurality of antennas each of which includes a fixed beam gain (an antenna gain, antenna directionality, or beam directionality), and can perform the beamforming transmission by switching between the plurality of antennas.

The base station apparatus 1 can perform the beamforming transmission and thus also can use a higher radio frequency than with the first communication mode. Because of this, a radio resource is easy to secure. Furthermore, the base station apparatus 1 performs the beamforming transmission and thus can increase coverage by the base station apparatus 1. Consequently, in the communication system according to the present embodiment, a specific base station apparatus 1 performs the beamforming transmission and uses a radio frequency higher than a radio frequency that is used by the first communication mode. Thus, the base station apparatus 1 can always transmit a signal to the terminal apparatus 2 based on the second communication mode. Because of this, the shortening of a communication latency, which is a required condition that the second communication mode has to satisfy, can be realized more suitably.

The base station apparatus 1 according to the present embodiment includes in advance a plurality of transmission weightings (a transmission filter, a filter, and an amount of phase rotation) for performing the beamforming, and can know in advance how the coverage by the base station apparatus 1 changes, by each transmission weighting.

However, the base station apparatus 1 that uses the beamforming technology needs information relating to a channel between the base station apparatus 1 itself and the terminal apparatus that is a destination of the transmission signal. At this point, complex channel gain information between the base station apparatus 1 and the terminal apparatus is suitable as the information relating to the channel between the base station apparatus 1 and the terminal apparatus that is the destination. However, information that is sufficient for the base station apparatus 1 to use the beamforming technology may be available. For example, the base station apparatus 1 acquires positional information of the terminal apparatus that is the destination of the transmission signal, and thus can use the beamforming technology. However, in the communication system in the related art, in order for the transmission apparatus to use the beamforming technology, the information relating to the channel as described above is transmitted and received as the control information. Because of this, overload of the communication system is caused to increase.

In the communication system according to the present embodiment, the first information that is transmitted by the terminal apparatus 2 using the first communication mode is the apparatus surrounding information of the terminal apparatus 2. Because of this, the base station apparatus 1 can perform the beamforming transmission based on the apparatus surrounding information (surrounding information) of the terminal apparatus 2. For example, if the apparatus surrounding information of the terminal apparatus 2 is a moving image that is acquired by a camera device which is mounted in the terminal apparatus 2, the base station apparatus 1 can estimate a place in which the terminal apparatus 2 is currently positioned, based on the moving image. Because of this, based on the information, the base station apparatus 1 can perform the beamforming.

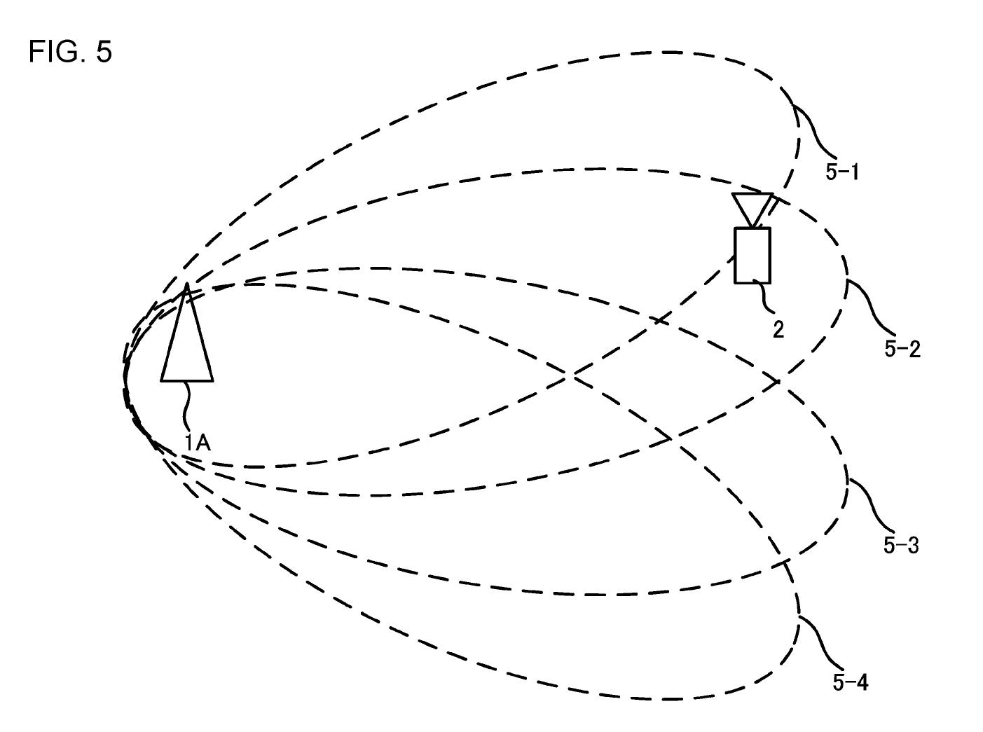

FIG. 5 is a diagram illustrating an example of the aspect of the communication system according to the present embodiment. The communication system in FIG. 5 includes the base station apparatus 1A and the terminal apparatus 2. Furthermore, 5-1 to 5-4 are coverage by the base station apparatus 1A, and the base station apparatus 1A corresponds to a change in coverage in a case where different types of beamforming are performed. That is, in FIG. 5, the base station apparatus 1A can use four transmission filters, that is, transmission filters 6-1 to 6-4, and the coverage by the base station apparatus 1A corresponds to the coverage 5-1 in a case where the base station apparatus 1A uses the transmission filter 6-1.

It is noted that in the present embodiment, a beamforming technique that is performed by the base station apparatus 1A is not limited to any beamforming technique. The base station apparatus 1A may use the analog beamforming and may use the digital beamforming. Furthermore, the base station apparatus 1A, as illustrated in FIG. 5, may include a plurality of types of transmission filters in advance. As described above, based on the information on the apparatus vicinity of the terminal apparatus 2, which is transmitted by the terminal apparatus 2 based on the first communication mode, the transmission filter may be calculated each time. However, the use of the beamforming by the base station apparatus itself causes the base station apparatus 1A to suitably know how the coverage by the base station apparatus 1A itself changes.

In the present embodiment, the base station apparatus 1 determines the transmission filter of the base station apparatus 1 itself based on the information on the apparatus vicinity of the terminal apparatus 2, which is transmitted by the terminal apparatus 2 using the first communication mode. For example, in a case where, with the information on the apparatus vicinity of the terminal apparatus 2, it is determined that the terminal apparatus 2 is present in the coverage 5-2, the base station apparatus 1 may perform the beamforming using a transmission filter 6-2 that realizes coverage 5-2.

Furthermore, in the communication system according to the present embodiment, the base station apparatus 1 to which the terminal apparatus 2 transmits moving image data in which information is contained, based on the first communication mode, can transmit information to the terminal apparatus 2 based on the second communication mode. At this point, the information being contained in the moving image data refers to the fact that information (an appearance of the base station apparatus 1 or the like) indicating the base station apparatus 1 is reflected in the moving age data. Furthermore, the information being contained in the moving image data refers to a case where the base station apparatus 1 transmits information at a specific frequency or in a specific phase and where the information is contained in the moving image data, as well. With the moving image data, the communication system according to the present embodiment can determine the base station apparatus 1 that makes the beamforming toward the terminal apparatus 2 possible. Furthermore, with the moving image data, the direction of the terminal apparatus 2 when viewed from the base station apparatus 1 can be also estimated. Because of this, the base station apparatus 1 can perform the beamforming transmission suitable for the terminal apparatus 2.

Furthermore, the communication system according to the present embodiment selects the base station apparatus 1 from among the base station apparatuses 1 that can realize the second communication mode based on the method described above, and can perform the communication that is based on the second communication mode.

It is noted that in the beamforming technology, because there is a need to set a beam to be toward an apparatus that is a destination of a signal, a state where communication cannot necessarily be performed occurs depending on a positional relationship between the transmission apparatus and the reception apparatus. Take, for example, FIG. 5. If the terminal apparatus 2 is not present even within any coverage by the base station apparatus 1A, the base station apparatus 1A cannot perform signal transmission to the terminal apparatus 2, which uses the beamforming technology.

For this reason, in the communication system according to the present embodiment, even in a state where information that has to be transmitted to the terminal apparatus 2 by performing the communication that is based on the second communication mode is not present, the base station apparatus 1 can always continue to transmit some information to the terminal apparatus 2 by performing the beamforming transmission. This communication is hereinafter referred to as acknowledgement communication. With the acknowledgement communication, a response signal in response to the transmission signal can be transmitted. The base station apparatus 1 that starts the acknowledgement communication receives the response signal from the terminal apparatus 2 and thus can know that the acknowledgement communication is correctly performed. While the acknowledgement communication is correctly performed, this means that the base station apparatus 1 can realize the beamforming transmission to the terminal apparatus 2. Because of this, if information occurs that has to be transmitted by performing the communication that is based on the second communication mode, the base station apparatus 1 can quickly transmit the information to the terminal apparatus 2, by performing the communication that is based on the second communication mode which includes the beamforming transmission.

On the other hand, in a case where the base station apparatus 1 determines that the acknowledgement communication is not correctly performed, this means that the base station apparatus 1 does not perform the communication based on the second communication mode with terminal apparatus 2. In this case, the base station apparatus 1 can perform signaling of information, which indicates that the communication based on the second communication mode is not performed, to the terminal apparatus 2. In this case, the terminal apparatus 2 may make an attempt to make a connection to another base station apparatus 1, and may no longer use the communication service that is provided using the communication system.

With the method described so far above, the communication system can realizes the communication using the second communication mode, based on the information that is transmitted using the first communication mode. Because of this, the overhead of the communication system can be reduced and a high-efficiency communication service can be provided.

### 3. Aspects Common to all Embodiments

It is noted that a program that operates on each of the apparatuses according to an aspect of the present invention is a program (a program that causes a computer to function) that controls a CPU or the like in such a manner as to realize a function of the embodiment according to the aspect of the present invention, which is described above. Then, pieces of information that are handled in each of the apparatuses are temporarily accumulated in a RAM when processed, and thereafter, are stored in various ROMs or HDDs. The CPU performs reading, correcting, and writing of the pieces of information whenever necessary. Of a semiconductor medium (for example, a ROM, a nonvolatile memory card, or the like), an optical storage medium (for example, a DVD, a MO, a MD, a CD, a BD, and the like), a magnetic storage medium (for example, a magnetic tape, a flexible disk, or the like), and the like, any one may be possible as a recording medium on which to store the program. Furthermore, in some cases, functions of each of the embodiments described above are realized by executing the program that is loaded, and in addition, functions according to an aspect of the present invention are realized by performing processing in conjunction with an operating system or other application programs, based on an instruction from the program.

Furthermore, in a case where the programs are distributed on the market, the programs, each of which is stored on a portable recording medium, can be distributed, or can be transferred to a server computer that is connected through a network, such as the Internet. In this case, a storage device of the server computer also falls within the scope of an aspect of the present invention. Furthermore, some or all of the portions of each of the apparatuses according to the embodiments, which are described above, may be realized as an LSI that is a typical integrated circuit. Each of the functional blocks of each of the apparatuses may be individually built into a chip, and some or all of the functional blocks may be integrated into a chip. In a case where each of the functional blocks is integrated into a circuit, an integrated circuit control unit is added that controls the functional blocks.

Furthermore, a technique for the integrated circuit is not limited to the LSI, and an integrated circuit for the functional block may be realized as a dedicated circuit or a general-purpose processor. Furthermore, if with advances in a semiconductor technology, a circuit integration technology with which an LSI is replaced appears, of course, it is also possible that an integrated circuit to which such a technology is applied is used.

It is noted that the present application in the present application is not limited to the embodiments described above. It goes without saying that, for example, the terminal apparatus 2 according to the present invention in the present application is not limited to application to a mobile station apparatus and can also be applied to a fixed-type electronic apparatus that is installed indoors or outdoors, or a stationary-type electronic apparatus, for example, an AV apparatus, a kitchen apparatus, a cleaning or washing machine, an air conditioner, office equipment, a vending machine, and other household apparatuses.

The embodiments of the invention are described in detail above with reference to the drawings, but a specific configuration is not limited to the embodiments, A design and the like that do not depart from the gist of the invention fall within the scope of claims as well.

### INDUSTRIAL APPLICABILITY

The present invention is suitable for use in a communication system and a base station apparatus.

It is noted that the present international application claims the benefits of Japanese Patent Application No. 2015-170061 filed on Aug. 31, 2015, and that the entire contents of Japanese Patent Application No. 2015-170061 are incorporated herein by reference.

### REFERENCE SIGNS LIST

1, 1A, 1B, 1C, 1D base station apparatus
2 terminal apparatus
101 higher layer processing unit
102 control unit
103 transmission unit
104 reception unit
105 transmit and receive antenna
1011 radio resource control unit
1012 scheduling unit
1031 coding unit
1032 modulation unit
1033 downlink reference signal generation unit
1034 multiplexing unit
1035 wireless transmission unit
1041 wireless reception unit
1042 demultiplexing unit
1043 demodulation unit
1044 decoding unit
201 higher layer processing unit
202 control unit
203 transmission unit
204 reception unit
205 channel state information generating unit
206 transmit and receive antenna
2011 radio resource control unit
2012 scheduling information analysis unit
2031 coding unit
2032 modulation unit
2033 downlink reference signal generation unit
2034 multiplexing unit
2035 wireless transmission unit
2041 wireless reception unit
2042 demultiplexing unit
2043 signal detection unit

1. A communication system that includes a base station apparatus and a terminal apparatus and provides a communication service based on a plurality of communication modes that satisfy different communication qualities,
wherein the plurality of communication modes includes a first communication mode and a second communication mode,
wherein a communication route included in the first communication mode and a communication route included in the second communication mode are different from each other, and
wherein a trigger for the base station apparatus to start communication based on the second communication mode is included in information transmitted by the terminal apparatus in accordance with the first communication mode.

2. The communication system according to claim 1, further comprising a plurality of base station apparatuses, each of which is the base station apparatus,
wherein, among the plurality of base station apparatuses, the communication route included in the first communication mode is a communication path between a base station apparatus having the highest first communication quality and the terminal apparatus, and
wherein, among the plurality of base station apparatuses, the communication route included in the second communication mode is a communication path between a base station apparatus having the highest second communication quality and the terminal apparatus.

3. The communication system according to claim 2,
wherein the base station apparatus having the highest first communication quality is a base station apparatus having the highest reception quality of a signal from the terminal apparatus, and
wherein the base station apparatus having the highest second communication quality is a base station apparatus capable of securing a radio resource required between the base station apparatus itself and the terminal apparatus.

4. The communication system according to claim 3,
wherein a radio resource that is used for the second communication mode is determined based on a radio resource that is used for the first communication mode.

5. The communication system according to claim 1,
wherein the second communication mode is a communication mode including a beamforming transmission, and
wherein the base station apparatus performs the beamforming transmission in accordance with information that is transmitted by the terminal apparatus in accordance with the first communication mode.

6. The communication system according to claim 5,
wherein information acquired by the terminal apparatus in accordance with the first communication mode is surrounding information of the terminal apparatus, and
wherein the base station apparatus acquires positional information of the terminal apparatus in accordance with the surrounding information and performs the beamforming transmission in accordance with the positional information.

7. The communication system according to claim 2,
wherein, in a case where the communication based on the second communication mode does not satisfy the required second communication quality, the base station apparatus performs signaling of information, which indicates that the communication based on the second communication mode does not satisfy the required second communication quality, to the terminal apparatus.

8. The communication system according to claim 2,
wherein the first communication quality is a data rate and
wherein the second communication quality is a communication latency time.

9. A base station apparatus that is included in a communication system which provides a communication service based on a plurality of communication modes that satisfy different communication qualities and communicates with a terminal apparatus,
wherein the plurality of communication modes include a first communication mode and a second communication mode,
wherein the second communication mode is a communication mode including a beamforming transmission,
wherein the base station apparatus includes a transmission unit that performs the beamforming transmission, and
wherein the transmission unit performs the beamforming transmission in accordance with information that is transmitted by the terminal apparatus in accordance with the first communication mode.
